(19) United States
(12) Patent Application Publication
(10) Pub. No.: US 2020/0305413 A1
(43) Pub. Date: Oct. 1, 2020

(54) Hunting Apparatus

(71) Applicant: FadeOut, LLC, Grand Rapids, MI (US)

(72) Inventor: Matthew THAYER, Grand Rapids, MI (US)

(73) Assignee: FadeOut, LLC, Grand Rapids, MI (US)

(21) Appl. No.: 16/368,033

(22) Filed: Mar. 28, 2019

(51) Int. Cl. A01M 31/02

(52) U.S. Cl. CPC A01M 31/025; A01M 31/02

(57) ABSTRACT

A hunting apparatus that includes a hunting blind adapted to extend around a ladder stand. The hunting blind includes a first panel member and second panel member that are attached to each other at peripheries thereof. The first and second panel members are made of a stretchable material and cooperate with each other such that the hunting blind is opaque when extended around the ladder stand. The hunting blind forms at least one arcuate panel section when the hunting blind is extended around the ladder stand.

### FIELD

The present disclosure relates to a hunting apparatus.

### BACKGROUND

This section provides background information related to the present disclosure which is not necessarily prior art.

Blind assemblies are used to camouflage and/or conceal someone or something from a target, such as for surveillance or hunting game animals. Conventional blind assemblies are often heavy and difficult to transport from one location to another. Conventional blind assemblies are also not adaptable to poor conditions (wind or rain, for example).

The blind assembly of the present disclosure is adaptable to poor conditions and allows convenient transport of the blind assembly from one site to another.

### SUMMARY

This section provides a general summary of the disclosure, and is not a comprehensive disclosure of its full scope or all of its features.

In one form, the present disclosure provides a hunting apparatus that includes a hunting blind adapted to extend around a ladder stand. The hunting blind includes a first panel member and a second panel member that are attached to each other. The first and second panel members are made of a stretchable material and cooperate with each other such that the hunting blind is opaque when extended around the ladder stand. The hunting blind forms at least one arcuate panel section when the hunting blind is extended around the ladder stand.

In some configurations of the hunting apparatus of the above paragraph, each of the first and second panel members are one of a spandex and elastane material.

In some configurations of the hunting apparatus of any one or more of the above paragraphs, each of the first and second panel members are allowed to stretch between 1% and 300% of the original steady state size.

In some configurations of the hunting apparatus of any one or more of the above paragraphs, a zipper is attached to the hunting blind and movable between an open position and a closed position. The hunting blind forms an opening when the zipper is in the open position.

In some configurations of the hunting apparatus of any one or more of the above paragraphs, the first panel member and the second panel member are attached to each other at peripheries thereof such that a hem is formed around the hunting blind.

In another form, the present disclosure provides a hunting apparatus that includes a ladder stand and a hunting blind. The ladder stand is attached to a support member. The hunting blind is attached to and extends around the ladder stand. The hunting blind is made of a stretchable material. The hunting blind forms at least one arcuate panel section when the hunting blind is extended around the ladder stand.

In some configurations of the hunting apparatus of the above paragraph, the hunting blind is one of a spandex and elastane material.

In some configurations of the hunting apparatus of any one or more of the above paragraphs, the hunting blind is allowed to stretch between 1% and 300% of the hunting blind steady state size.

In some configurations of the hunting apparatus of any one or more of the above paragraphs, attachment members attach the hunting blind to the ladder stand. The attachment members are VELCRO hook-and-loop fasteners.

In some configurations of the hunting apparatus of any one or more of the above paragraphs, the hunting blind includes a first panel member and a second panel member that are attached to each other at peripheries thereof. The first and second panel members cooperate such that the hunting blind is opaque when extended around the ladder stand.

In some configurations of the hunting apparatus of any one or more of the above paragraphs, the first panel member and the second panel member are attached to each other at the peripheries thereof, thereby forming a hem that extends around the hunting blind.

In some configurations of the hunting apparatus of any one or more of the above paragraphs, the ladder stand includes a support rail that is rotatable between a stowed state in which entry into or departure out of the ladder stand is allowed, and a deployed state in which entry into or departure out of the ladder stand is restricted. The hem attaches to the support rail when the support rail is in the deployed state to facilitate grip between the hunting blind and the support rail.

In some configurations of the hunting apparatus of any one or more of the above paragraphs, the ladder stand includes a support rail that is rotatable between a stowed state in which entry into or departure out of the ladder stand is allowed, and a deployed state in which entry into or departure out of the ladder stand is restricted. The hem attaches to the support rail via clamps when the support rail is in the deployed state to facilitate grip between the hunting blind and the support rail.

In some configurations of the hunting apparatus of any one or more of the above paragraphs, a zipper is attached to a middle portion of the hunting blind and is movable between an open position in which entry into or departure out of the ladder stand is allowed and a closed position in which entry into or departure out of the ladder stand is prevented.

In yet another form, the present disclosures provides a hunting apparatus that includes a ladder stand and a hunting blind. The ladder stand is attached to a support member. The hunting blind is attached to and extends around the ladder stand. The hunting blind includes a first panel member and second panel member that are attached to each other at peripheries thereof. The first and second panel members are made of a stretchable material and cooperate with each other such that the hunting blind is opaque when extended around the ladder stand. The hunting blind forms a plurality of arcuate panel sections when the hunting blind is extended around the ladder stand.

In some configurations of the hunting apparatus of the above paragraph, each of the first and second panel members are one of a spandex and elastane material.

In some configurations of the hunting apparatus of any one or more of the above paragraphs, each of the first and second panel members are allowed to stretch between 1% and 300% of the original steady state size.

In some configurations of the hunting apparatus of any one or more of the above paragraphs, attachment members attach the hunting blind to the ladder stand. The attachment members are VELCRO hook-and-loop fasteners.

In some configurations of the hunting apparatus of any one or more of the above paragraphs, the first panel member and the second panel member are attached to each other such that a hem is formed around the hunting blind.

In some configurations of the hunting apparatus of any one or more of the above paragraphs, the ladder stand includes a support rail that is rotatable between a stowed state in which entry into or departure out of the ladder stand is allowed, and a deployed state in which entry into or departure out of the ladder stand is restricted. The hem attaches to the support rail when the support rail is in the deployed state to facilitate grip between the hunting blind and the support rail.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of the hunting apparatus having a hunting bling assembly and a ladder stand according to the principles of the present disclosure;

FIG. 2 is a back view of the hunting apparatus of FIG. 1 with a support rail of the ladder stand in a deployed state and a zipper of the hunting blind assembly in a closed position;

FIG. 3 is a perspective view of the hunting apparatus of FIG. 1 with the support rail in the deployed state and the zipper in an open position;

FIG. 4 is a front view of a hunting blind of the hunting blind assembly;

FIG. 5 is a perspective view of the ladder stand with the support rail in the deployed state;

FIG. 6 is a perspective view of the ladder stand with the support rail in a stowed state;

FIG. 7 is a perspective view of one attachment member of the hunting blind assembly;

FIG. 8 is a perspective view of an alternate attachment member;

FIG. 9 is a perspective view of another alternate attachment member;

FIG. 10 is a perspective view of another alternate attachment member;

FIG. 11 is a perspective view of another hunting apparatus having a hunting bling assembly and a ladder stand according to the principles of the present disclosure;

FIG. 12 is a back view of the hunting apparatus of FIG. 11 with a support rail of the ladder stand in a deployed state and a zipper of the hunting blind assembly in a closed position;

FIG. 13 is another perspective view of the hunting apparatus of FIG. 11 with the support rail of the ladder stand in the deployed state and the zipper of the hunting blind assembly in the closed position;

FIG. 14 is another perspective view of the hunting apparatus of FIG. 11 with the support rail of the ladder stand in the deployed state and the zipper of the hunting blind assembly in an open position; and

FIG. 15 is a perspective view of another hunting apparatus.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

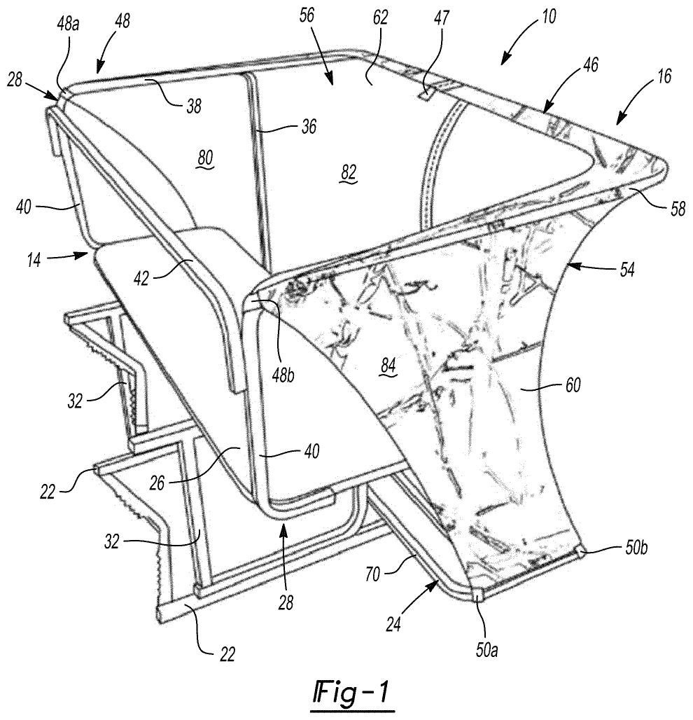

With reference to FIGS. 1-3, a hunting apparatus 10 may be attached to a primary support member (e.g., a tree) and may include a ladder (not shown), a ladder stand 14 and a hunting blind assembly 16. The ladder may be attached at an upper end to the ladder stand 14 and may be positioned on a ground surface (not shown) so that a user or hunter (not shown) on the ground surface may climb the ladder to access the ladder stand 14.

The ladder stand 14 may be attached to the primary support member via a plurality of connecting members (not shown). The ladder stand 14 may be attached to the primary support member so that it is positioned a predetermined distance (e.g., between 10 feet and 25 feet) above the ground surface. In this way, the hunter accessing the ladder stand 14 via the ladder (not shown) may hunt game animals, for example, on the ground surface. In some configurations, the hunter may hunt game animals that are off the ground surface (i.e., in a tree or flying in the air). A plurality of secondary support members (not shown) may be attached to the ladder and the primary support member, thereby further attaching the hunting apparatus 10 to the primary support member.

With reference to FIGS. 1-3, 5 and 6, the ladder stand 14 may be made out of a metallic material (e.g., aluminum) and may include bottom supports 22, a foot rest 24, a seat or bottom rest 26, a pair of side rails 28 and a support rail 30. The bottom supports 22 may be attached to the ladder (not shown) and may extend from a front of the ladder stand 14 toward the back of the ladder stand 14. The rectangular-shaped foot rest 24 may be attached to the bottom supports 22 at or near the front end thereof and may extend across the bottom supports 22 (i.e., opposing ends of the foot rest 24 extend past the bottom supports 22 in a lateral direction). In this way, the hunter (not shown) may place his feet on the foot rest 24 when using the ladder stand 14 to hunt game animals, for example.

As shown in FIGS. 1-3, 5 and 6, a bottom-rest support 32 may be made out of a metallic material (e.g., aluminum) and may be attached to a respective bottom support 22 at or near a rear end thereof. The rectangular-shaped bottom rest 26 may be attached to the bottom-rest supports 32 and may extend across the bottom-rest supports 32 (i.e., opposing ends of the bottom rest 26 extend past the bottom-rest supports 32 in a lateral direction). In this way, the hunter (not shown) may sit on the bottom rest 26 when using the ladder stand 14 to hunt game animals, for example. It should also be understood that the ladder stand 14 may be used to seat more than one hunter (e.g., two hunters).

Each side rail 28 may be tubular with a rectangular cross-section. Each side rail 28 may have a J-shape and may be attached to a respective end of the foot rest 24 and a respective end of the bottom rest 26. Each side rail 28 may include a first member 36, a second member 38 and a third member 40. The first member 36 extends parallel to the third member 40 and perpendicular to the second member 38. A lower end of the first member 36 may be attached to the respective end of the foot rest 24 and a lower end of the third member 40 may be attached to the respective end of the bottom rest 26. A back support 42 may be attached to upper ends of the third members 40 and may extend between the third members 40.

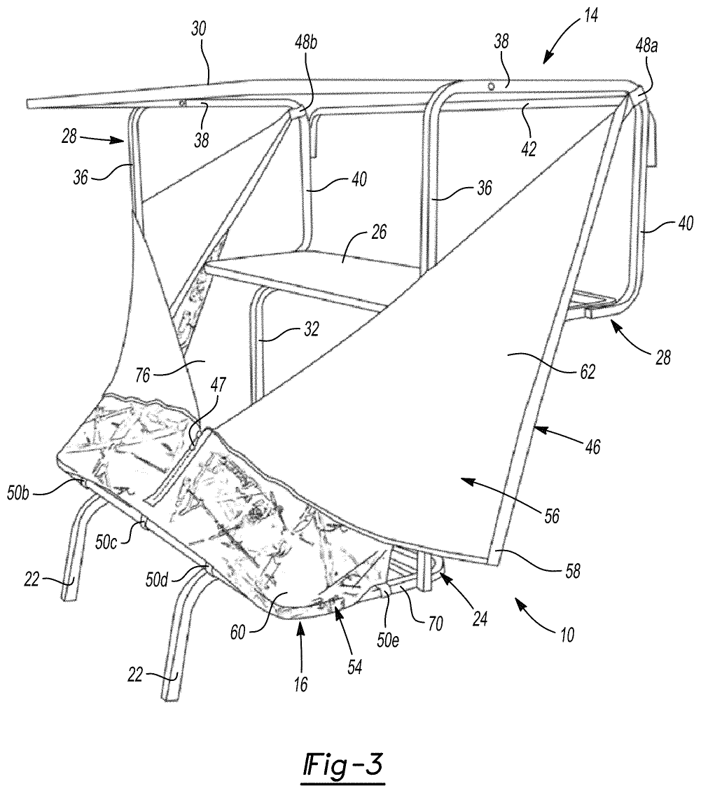

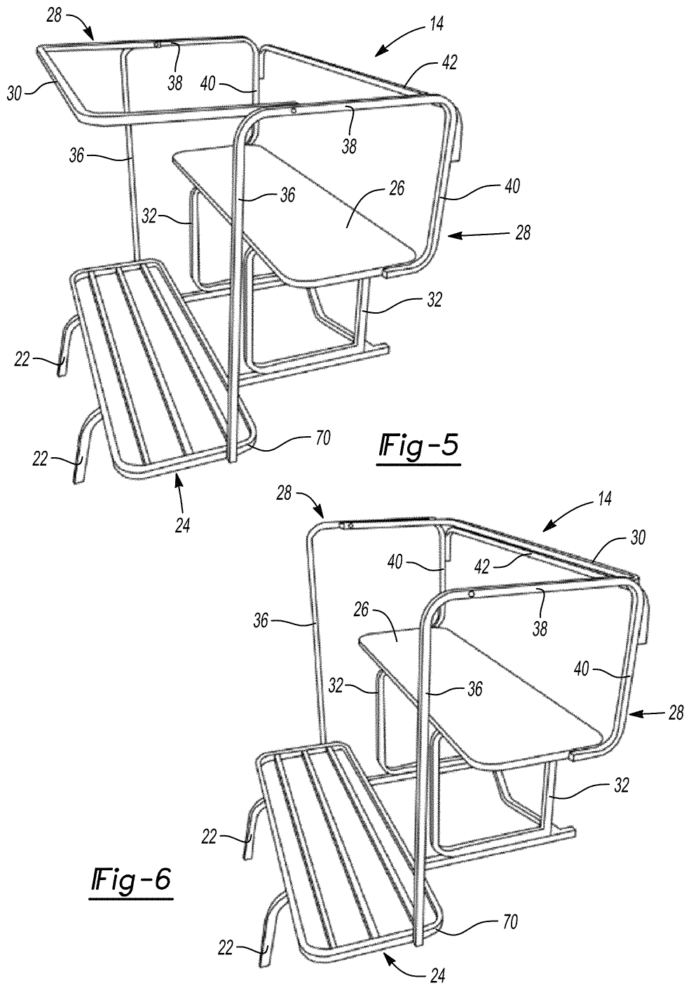

As shown in FIGS. 3, 5 and 6, the U-shaped support rail 30 may be attached to the second members 38 of the pair of side rails 28 (via fasteners (not shown)) at or near the front end thereof and may be rotatable between a stowed state (FIG. 6) and a deployed state (FIGS. 3 and 5). When the support rail 30 is in the stowed state, the hunter is allowed to enter or exit the ladder stand 14. When the support rail 30 is in the deployed state, the hunter may be restricted from entering or exiting the ladder stand 14. The support rail 30 is co-planar with the second members 38 of the side rails 28 when the support rail 30 is in the stowed and deployed states. When the support rail 30 is in the deployed state, the support rail 30 may support a hunting tool (e.g., bowing arrow, firearm) or other equipment (e.g., camera equipment). When the support rail 30 is in the deployed state, the support rail 30 may be positioned over or above the foot rest 24. When the support rail 30 is in the stowed state, the support rail 30 may be positioned adjacent to the back support 42.

As shown in FIGS. 1-4, the hunting blind assembly 16 may include a hunting blind 46, zipper 47, a plurality of first attachment members 48 (comprising attachment members 48a, 48b) and a plurality of second attachment members 50 (comprising attachment members 50a, 50b, 50c, 50d, 50e).

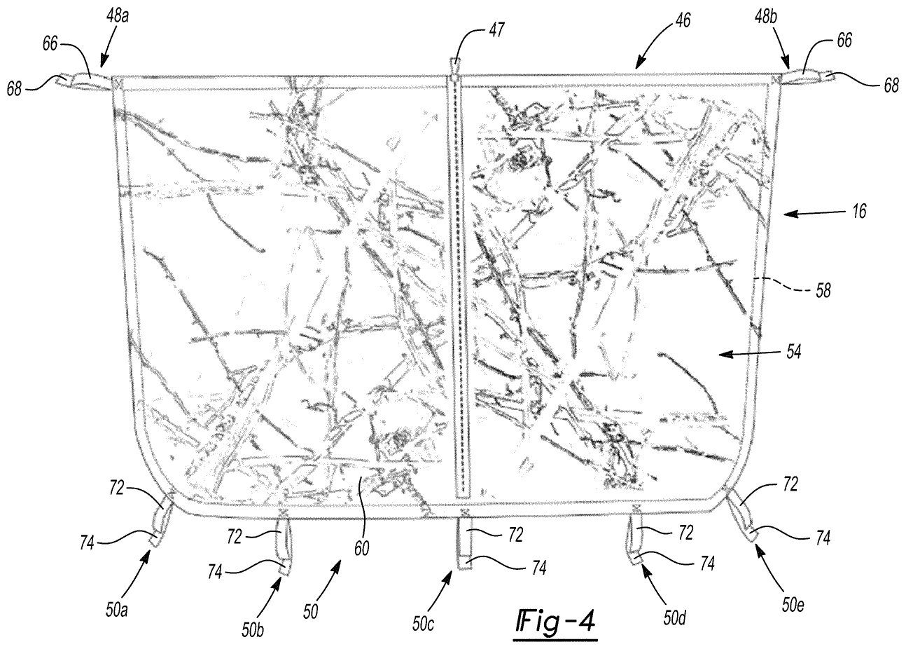

The hunting blind 46 may extend around the ladder stand 14 and may include first and second panel members 54, 56 that are sewn together at peripheries thereof, thereby forming a hem 58 (FIGS. 3 and 4) that extends around a periphery of the hunting blind 46. The hem 58 may facilitate the grip or attachment between the hunting blind 46 and the support rail 30 when the support rail 30 is in the deployed state. In this way, fasteners are not needed to attach the hunting blind 46 to the support rail 30.

Each of the first and second panel members 54, 56 may have a rectangular shape and may be made of a spandex or elastane material similar to Lycra®, Elaspan®, or Acepora®, for example. The spandex or elastane material allows for the hunting blind 46 to extend around the ladder stand 14 by stretching the hunting blind 46 (i.e., the first and second panel members 54, 56) around the ladder stand 14 such that the hunting blind 46 assumes or mimics the shape of the ladder stand 14 for a more natural appearance of the surveillance or hunting site. This also reduces movement of the hunting blind 46 when using it in windy conditions, for example, thereby eliminating sounds that would otherwise alert a surveillance target or alarm or scare off game animals.

The first and second panel members 54, 56 may cooperate such that the hunting blind 46 is opaque when stretched around the ladder stand 14, thereby eliminating shadows that may otherwise alert a surveillance target or scare off game animals. That is, if a hunting blind having a single panel member is used, the hunting blind may be transparent when stretched, thereby alerting a surveillance target or scaring off game animals. The hunting blind 46 (i.e., the first and second panel members 54, 56) may stretch between 1% and 300% of its original steady state size so that the hunting blind 46 conveniently extends around the ladder stand 14. Each of the first and second panel members 54, 56 may be a trapezoidal, pentagonal, or any other suitable shape that gives a natural appearance of the surveillance or hunting site once extended around the ladder stand 14.

The first panel member 54 may include a first side 60 and a second side (not shown). The first side 60 and the second side may be camouflaged so as to give the natural appearance of the surveillance or hunting site to targets or game animals once the hunting blind 46 is extended around the ladder stand 14. In some configurations, the second side may be a neutral color such as olive, for example. The second panel member 56 may include a first side 62 and a second side (not shown). The first side 62 and the second side may be a camouflage or neutral color such as olive, for example, so as to give the natural appearance of the surveillance or hunting site to targets or game animals.

As shown in FIGS. 1-4, the zipper 47 may be attached at a middle portion of the hunting blind 46 and may be movable between an open position in which the hunter is allowed to enter or leave the ladder stand 14 and a closed position in which the hunter is prevented from entering or leaving the ladder stand 14. In some configurations, the hunting blind assembly 16 may not include a zipper 47.

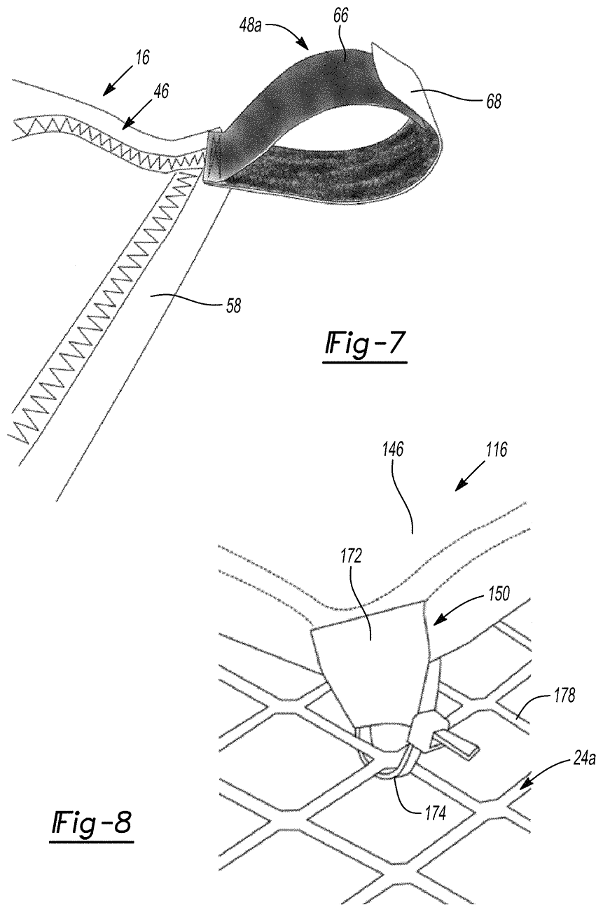

As shown in FIG. 4, each of the first attachment members 48a, 48b may be attached (e.g., sewn) to an end (i.e., where adjacent sides of the hunting blind 46 intersect) of the hunting blind 46 at an upper portion thereof and may be configured to wrap around a respective side rail 28. As shown in FIGS. 4 and 7, each of the first attachment members 48a, 48b may be hook-and-loop fasteners (i.e., VELCRO), for example, having a first tab 66 (i.e., hook tab) and a second tab 68 (i.e., loop tab). The first and second tabs 66, 68 may be attached to the hunting blind 46 such that the hooks and the loops face the same direction. In this way, when each of the first attachment members 48a, 48b wrap around the respective side rails 28, the first and second tabs 66, 68 are in contact with each other, thereby creating a strong bond between the tabs 66, 68.

As shown in FIG. 4, each of the second attachment members 50a, 50b, 50c, 50d, 50e may be attached (e.g., sewn) to an edge of the hunting blind 46 at a lower portion thereof such that the attachment members 50a, 50b, 50c, 50d, 50e are equally spaced apart from each other. Each of the second attachment members 50a, 50b, 50c, 50d, 50e may be configured to wrap around an outer tubular member 70 of the foot rest 24 (FIGS. 1-3). Each of the second attachment members 50a, 50b, 50c, 50d, 50e may be hook-and-loop fasteners (i.e., VELCRO), for example, having a first tab 72 (i.e., hook tab) and a second tab 74 (i.e., loop tab). The first and second tabs 72, 74 may be attached to the hunting blind 46 such that the hooks and the loops face the same direction. In this way, when each of the second attachment members 50a, 50b, 50c, 50d, 50e wrap around the outer member 70, the first and second tabs 72, 74 are in complete contact with each other, thereby creating a strong bond between the tabs 72, 74.

With continued reference to FIGS. 1-7, installation and operation of the hunting apparatus 10 will be described in detail. The user may first attach the ladder (not shown) and the ladder stand 14 to the primary support (e.g., a tree) via the connecting members (not shown) and the plurality of secondary support members (not shown).

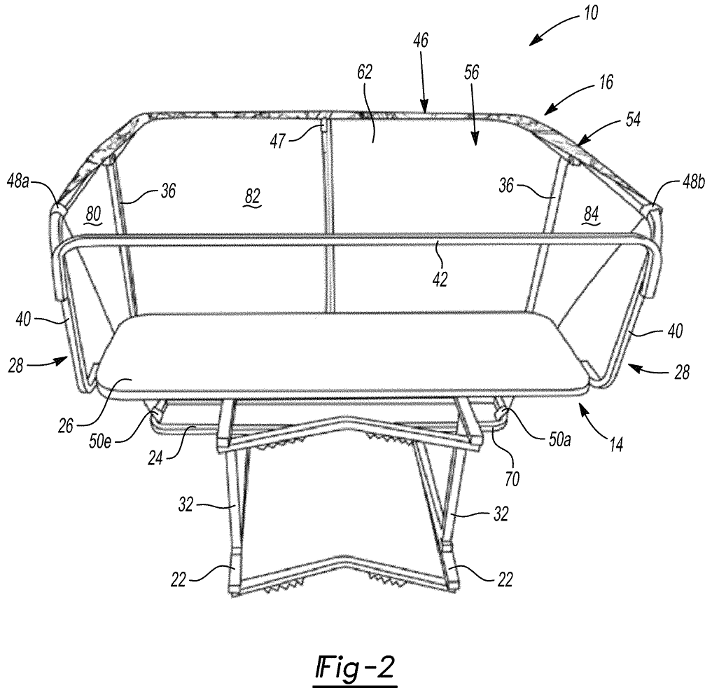

The user may then extend the hunting blind 46 around the ladder stand 14 (i.e., the hunting blind 46 is stretched around the side rails 28, the support rail 30 and the foot rest 24) and then may attach the first attachment members 48a, 48b to the respective side rails 28 and the second attachment members 50a, 50b, 50c, 50d, 50e to the foot rest 24. It should be understood that when the hunting blind 46 extends around the ladder stand 14, the hem 58 of the hunting blind 46 grips the support rail 30, thereby avoiding the need of fasteners to attach the hunting blind 46 to the support rail 30. It should also be understood that when the hunting blind 46 extends around the ladder stand 14, the hunting blind 46 forms arcuate first, second and third panel sections 80, 82, 84 (FIGS. 1 and 2), thereby giving the natural appearance of the surveillance or hunting site (i.e., each panel section 80, 82, 84 is curved as it extends from a lower portion of the hunting blind 46 toward an upper portion of the hunting blind 46).

The user may then climb the ladder and enter the ladder stand 14 (via an opening 76 (FIG. 3) in the hunting blind 46). Once the user is seated on the seat 26, the user may move the zipper 47 from the closed position to the closed position, thereby being hidden or concealed from the surveillance target or game animals.

It should be understood that in some configurations, the support rail 30 may be in the stowed state when the hunting blind 46 extends around the ladder stand 14, and the ladder and the ladder stand 14 are attached to the primary support. In such configurations, the user may rotate the support rail 30 from the stowed state to the deployed state after the user climbs the ladder and enters the ladder stand 14 (via the opening 76 of the hunting blind 46).

It should be understood that the hunting apparatus 10 may be used for other applications such as bird watching, wildlife photography, and military applications, for example. The hunting blind 46 may be adaptable for various ladder stands other than the ladder stand 14 disclosed herein.

With reference to FIG. 8, a blind assembly 116 is provided. The blind assembly 116 may be incorporated into the hunting apparatus 10 instead of blind assembly 16. The structure and function of the blind assembly 116 may be similar or identical to that of blind assembly 16 described above, apart from any exceptions noted below.

The hunting blind assembly 116 may include a hunting blind 146, zipper (not shown), a plurality of first attachment members (not shown) and a plurality of second attachment members 150 (only one shown in FIG. 8). The hunting blind 146 may be similar or identical to the hunting blind 46 described above, and therefore, will not be described again in detail. The zipper may be similar or identical to the zipper 47 described above, and therefore, will not be described again in detail.

Each of the second attachment members 150 may include a webbing loop 172 and a fastener 174 (e.g., a cable tie). The webbing loop 172 may be made out of nylon material and may be attached (e.g., sewn) to an edge of the hunting blind 146 at a lower portion thereof. The fastener 174 may extend through the webbing loop 172 and may extend around a grating 178 of a foot rest 24a, thereby securing the hunting blind 146 to the foot rest 24a.

The plurality of first attachment members (not shown) may be similar or identical to that of the second attachment members 150, and therefore, will not be described again in detail. The plurality of first attachment members may attach the hunting blind 146 to the side rails 28.

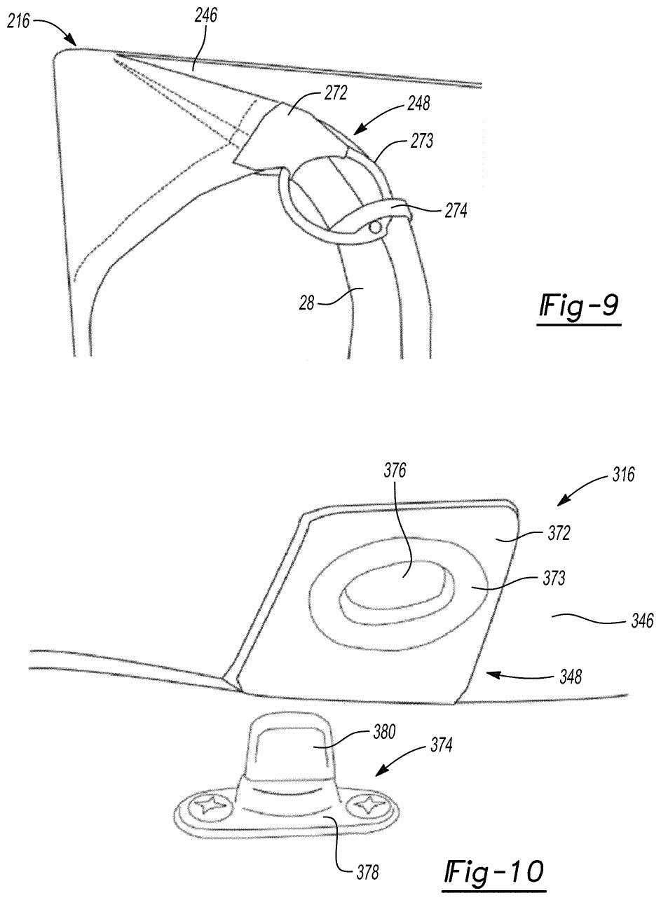

With reference to FIG. 9, a blind assembly 216 is provided. The blind assembly 216 may be incorporated into the hunting apparatus 10 instead of blind assemblies 16, 116. The structure and function of the blind assembly 216 may be similar or identical to that of blind assemblies 16, 116 described above, apart from any exceptions noted below.

The hunting blind assembly 216 may include a hunting blind 246, zipper (not shown), a plurality of first attachment members 248 (only one shown in FIG. 9) and a plurality of second attachment members (not shown). The hunting blind 246 may be similar or identical to the hunting blinds 46, 146 described above, and therefore, will not be described again in detail. The zipper may be similar or identical to the zipper 47 described above, and therefore, will not be described again in detail.

Each of the first attachment members 248 may include a webbing loop 272, a binder ring 273 and a fastener 274 (e.g., a cable tie). The webbing loop 272 may be made out of nylon material and may be attached (e.g., sewn) to an edge of the hunting blind 246 at an upper portion thereof. The binder ring 273 may be attached to the webbing loop 272. The fastener 274 may extend through the binder ring 273 and may extend around a respective side rail 28, thereby securing the hunting blind 246 to the side rails 28.

The plurality of second attachment members (not shown) may be similar or identical to that of the first attachment members 248, and therefore, will not be described again in detail. The plurality of second attachment members may attach the hunting blind 246 to the foot rest 24.

With reference to FIG. 10, a blind assembly 316 is provided. The blind assembly 316 may be incorporated into the hunting apparatus 10 instead of blind assemblies 16, 116, 216. The structure and function of the blind assembly 316 may be similar or identical to that of blind assemblies 16, 116, 216 described above, apart from any exceptions noted below.

The hunting blind assembly 316 may include a hunting blind 346, zipper (not shown), a plurality of first attachment members 348 (only one shown in FIG. 10) and a plurality of second attachment members (not shown). The hunting blind 346 may be similar or identical to the hunting blinds 46, 146, 246 described above, and therefore, will not be described again in detail. The zipper may be similar or identical to the zipper 47 described above, and therefore, will not be described again in detail.

Each of the first attachment members 348 may include a webbing loop 372, a first grommet 373 and a second grommet 374. The webbing loop 372 may be made out of nylon material and may be attached (e.g., sewn) to an edge of the hunting blind 346 at an upper portion thereof. The first grommet 373 may be attached to the webbing loop 372 and may include an opening 376 therein. The second grommet 374 may be attached to the ladder stand 14 (e.g., the side rails 28) and may include a base 378 and a locking member 380. The base 378 is attached to the ladder stand 14. The locking member 380 may be rotatable relative to the base 378 between a locked position and an unlocked position. When in the unlocked position, the locking member 380 may be received in the opening 376 of the first grommet 373. Once the locking member 380 is received in the opening 376 of the first grommet 373, the locking member 380 may be rotated to the locked position to attach the first grommet 373 to the second grommet 374. In this way, the hunting blind 346 is attached to the ladder stand 14.

The plurality of second attachment members (not shown) may be similar or identical to that of the first attachment members 348, and therefore, will not be described again in detail. The plurality of second attachment members may attach the hunting blind 346 to the foot rest 24.

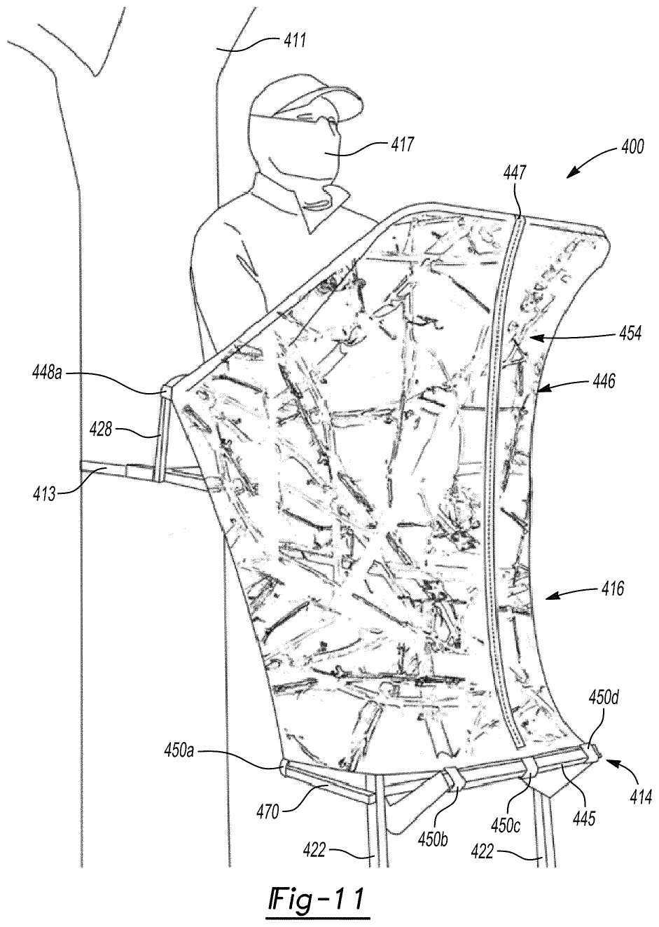

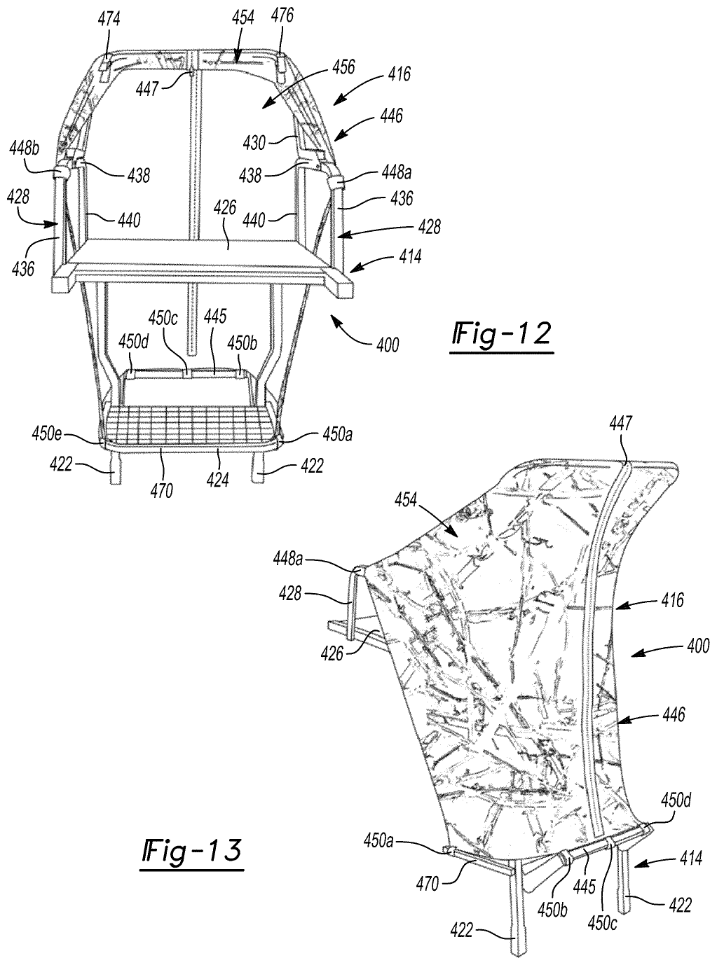

With reference to FIGS. 11-14, another hunting apparatus 400 is provided. The structure and function of the hunting apparatus 400 may be similar or identical to the hunting apparatus 10 described above, apart from any exceptions noted below.

The hunting apparatus 400 may be attached to a primary support member 411 (e.g., a tree) and may include a ladder (not shown), a ladder stand 414 and a hunting blind assembly 416.

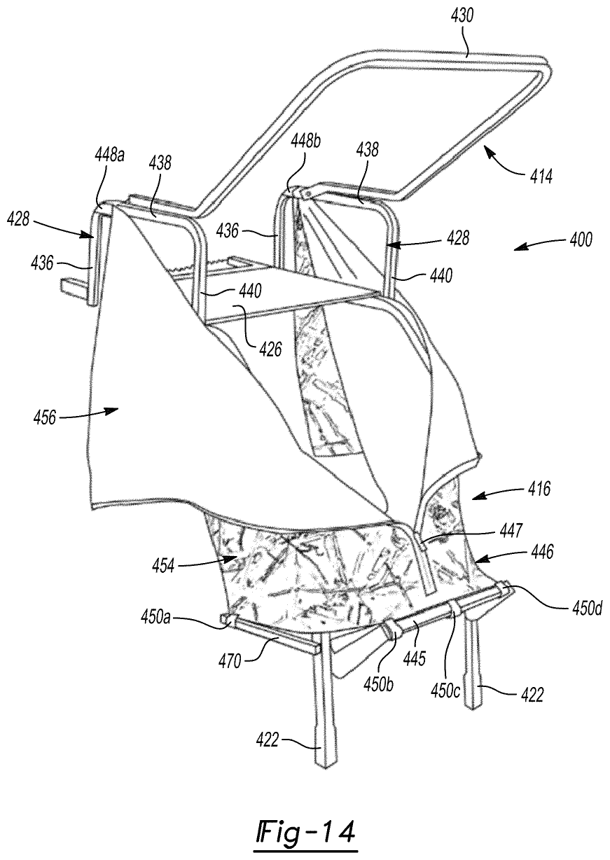

As shown in FIG. 11, the ladder stand 414 may be attached to the primary support member 411 via a connecting member 413. The ladder stand 414 may be attached to the primary support member 411 so that it is positioned a predetermined distance (e.g., between 10 feet and 25 feet) above the ground surface. With reference to FIGS. 11-14, the ladder stand 414 may be made out of a metallic material (e.g., aluminum) and may include first supports rails 422, a foot rest 424 (FIG. 12), a seat or bottom rest 426 (FIG. 12-14), a pair of side rails 428 and a second support rail 430 (FIGS. 12 and 14). The first support rails 422 may be attached to the ladder (not shown) and may be attached to the seat 426. The foot rest 424 may be attached to the first support rails 422. In this way, a hunter 417 may place his feet on the foot rest 424 when using the ladder stand 414 to hunt game animals, for example.

Each side rail 428 may be tubular with a rectangular cross-section. Each side rail 428 may be U-shaped and may be attached to a respective first support rail 422. Each side rail 428 may include a first member 436, a second member 438 and a third member 440. The first member 436 extends parallel to the third member 440 and perpendicular to the second member 438.

The U-shaped second support rail 430 may be attached to the second members 438 of the pair of side rails 428 (via fasteners (not shown)) and may be rotatable between a stowed state (not shown) and a deployed state (FIG. 14). When the second support rail 430 is in the stowed state, the hunter 417 is allowed to enter or exit the ladder stand 414. When the second support rail 430 is in the deployed state, the hunter 417 may be restricted from entering or exiting the ladder stand 414. The second support rail 430 may be positioned above the side rails 428 when the second support rail 430 is in the stowed and deployed states. When the second support rail 430 is in the deployed state, the second support rail 430 may support a hunting tool (e.g., bowing arrow, firearm) or other equipment (e.g., camera equipment).

As shown in FIGS. 11-14, a foot bar 445 may be made out of metallic material (e.g., aluminum) and may be attached to the first support rails 422. A portion of the foot bar 445 may be positioned above the foot rest 424.

The hunting blind assembly 416 may include a hunting blind 446, zipper 447, a plurality of first attachment members 448 (comprising attachment members 448a, 448b) and a plurality of second attachment members 450 (comprising attachment members 450a, 450b, 450c, 450d, 450e).

The hunting blind 446 may extend around the ladder stand 414 and may include first and second panel members 454, 456 that are sewn together at peripheries thereof, thereby forming a hem (not shown) that extends around a periphery of the hunting blind 446. The hem may facilitate the grip or attachment between the hunting blind 446 and the second support rail 430 when the second support rail 430 is in the deployed state.

Each of the first and second panel members 454, 456 may have a rectangular shape and may be made of a spandex or elastane material similar to Lycra®, Elaspan®, or Acepora®, for example. The spandex or elastane material allows for the hunting blind 446 to extend around the ladder stand 414 by stretching the hunting blind 446 (i.e., the first and second panel members 454, 456) around the ladder stand 414 such that the hunting blind 446 assumes or mimics the shape of the ladder stand 414 for a more natural appearance of the surveillance or hunting site. This also reduces movement of the hunting blind 446 when using it in windy conditions, for example, thereby eliminating sounds that would otherwise alert a surveillance target or alarm or scare off game animals.

Each of the first attachment members 448a, 448b may be attached (e.g., sewn) to an end (i.e., where adjacent sides of the hunting blind 446 intersect) of the hunting blind 446 at an upper portion thereof and may be configured to wrap around a respective side rail 428. Each of the first attachment members 448a, 448b may be hook-and-loop fasteners (i.e., VELCRO), for example.

As shown in FIG. 12, first and second clamps 474, 476 (e.g., spring-loaded clamps) may attach the hunting blind 446 to a portion of the second support rail 430. In some configurations, the clamps 474, 476 may attach the hunting blind 446 to the portion of the second support rail 430 that is positioned at least 8 inches above the side rails 428.

Each of the second attachment members 450a, 450b, 450c, 450d, 450e may be attached (e.g., sewn) to an edge of the hunting blind 446 at a lower portion thereof. Each of the second attachment members 450a, 450b, 450c, may be configured to wrap around the foot bar 445. Each of the second attachment members 450d, 450e may be configured to wrap around an outer tubular member 470 of the foot rest 424. Each of the second attachment members 450a, 450b, 450c, 450d, 450e may be hook-and-loop fasteners (i.e., VELCRO), for example.

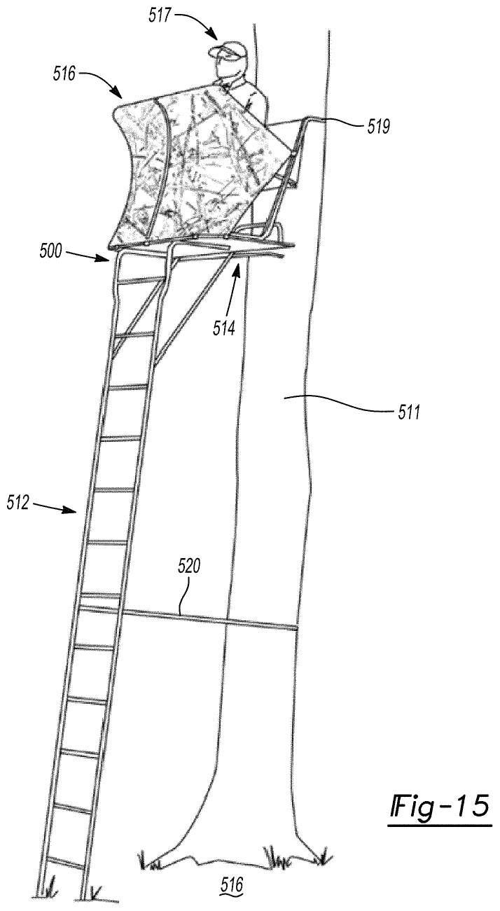

With reference to FIG. 15, another hunting apparatus 500 is provided. The structure and function of the hunting apparatus 500 may be similar or identical to the hunting apparatuses 10, 400 described above, apart from any exceptions noted below.

The hunting apparatus 500 may be attached to a primary support member 511 (e.g., a tree) and may include a ladder 512, a ladder stand 514 and a hunting blind assembly 516. The ladder 512 may be attached at an upper end to the ladder stand 514 and may be positioned on a ground surface 516 so that a user or hunter 517 may climb the ladder to access the ladder stand 514.

The ladder stand 514 may be attached to the primary support member 511 via at least one connecting member 519. The ladder stand 514 may be attached to the primary support member 511 so that it is positioned a predetermined distance (e.g., between 10 feet and 25 feet) above the ground surface 516. In this way, the hunter 517 accessing the ladder stand 514 via the ladder 512 may hunt game animals, for example, on the ground surface 516. In some configurations, the hunter 517 may hunt game animals that are off the ground surface 516 (i.e., in a tree or flying in the air). A secondary support member 520 may be attached to the ladder 512 and the primary support member 511, thereby further attaching the hunting apparatus 500 to the primary support member 511.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hunting apparatus comprising;
a hunting blind adapted to extend around a ladder stand, the hunting blind includes a first panel member and a second panel member that are attached to each other, the first and second panel members are made of a stretchable material and cooperate with each other such that the hunting blind is opaque when extended around the ladder stand,
wherein the hunting blind forms at least one arcuate panel section when the hunting blind is extended around the ladder stand.

2. The hunting apparatus of claim 1, wherein each of the first and second panel members are one of a spandex and elastane material.

3. The hunting apparatus of claim 1, wherein each of the first and second panel members are allowed to stretch between 1% and 300% of the original steady state size.

4. The hunting apparatus of claim 1, further comprising a zipper attached to the hunting blind and movable between an open position and a closed position, and wherein an opening is formed in the hunting blind when the zipper is in the open position.

5. The hunting apparatus of claim 1, wherein the first panel member and the second panel member are attached to each other at peripheries thereof such that a hem is formed around the hunting blind.

6. A hunting apparatus comprising:
a ladder stand attached to a support member; and
a hunting blind attached to and extending around the ladder stand, the hunting blind made of a stretchable material,
wherein the hunting blind forms at least one arcuate panel section when the hunting blind is extended around the ladder stand.

7. The hunting apparatus of claim 6, wherein the hunting blind is one of a spandex and elastane material.

8. The hunting apparatus of claim 6, wherein the hunting blind is allowed to stretch between 1% and 300% of the hunting blind steady state size.

9. The hunting apparatus of claim 6, further comprising attachment members attaching the hunting blind to the ladder stand, and wherein the attachment members are VELCRO hook-and-loop fasteners.

10. The hunting apparatus of claim 6, wherein the hunting blind includes a first panel member and a second panel member that are attached to each other at peripheries thereof, and wherein the first and second panel members cooperate such that the hunting blind is opaque when extended around the ladder stand.

11. The hunting apparatus of claim 10, wherein the first panel member and the second panel member are attached to each other at the peripheries thereof, thereby forming a hem that extends around the hunting blind.

12. The hunting apparatus of claim 11, wherein the ladder stand includes a support rail that is rotatable between a stowed state in which entry into or departure out of the ladder stand is allowed, and a deployed state in which entry into or departure out of the ladder stand is restricted, and wherein the hem attaches to the support rail when the support rail is in the deployed state to facilitate grip between the hunting blind and the support rail.

13. The hunting apparatus of claim 11, wherein the ladder stand includes a support rail that is rotatable between a stowed state in which entry into or departure out of the ladder stand is allowed, and a deployed state in which entry into or departure out of the ladder stand is restricted, and wherein the hem attaches to the support rail via clamps when the support rail is in the deployed state to facilitate grip between the hunting blind and the support rail.

14. The hunting apparatus of claim 6, further comprising a zipper that is attached to a middle portion of the hunting blind and is movable between an open position in which entry into or departure out of the ladder stand is allowed and a closed position in which entry into or departure out of the ladder stand is prevented.

15. A hunting apparatus comprising:
a ladder stand attached to a support member; and
a hunting blind attached to and extending around the ladder stand, the hunting blind includes a first panel member and second panel member that are attached to each other at peripheries thereof, the first and second panel members are made of a stretchable material and cooperate with each other such that the hunting blind is opaque when extended around the ladder stand,
wherein the hunting blind forms a plurality of arcuate panel sections when the hunting blind is extended around the ladder stand.

16. The hunting apparatus of claim 15, wherein each of the first and second panel members are one of a spandex and elastane material.

17. The hunting apparatus of claim 15, wherein each of the first and second panel members are allowed to stretch between 1% and 300% of the original steady state size.

18. The hunting apparatus of claim 15, further comprising attachment members attaching the hunting blind to the ladder stand, and wherein the attachment members are VELCRO hook-and-loop fasteners.

19. The hunting apparatus of claim 15, wherein the first panel member and the second panel member are attached to each other such that a hem is formed around the hunting blind.

20. The hunting apparatus of claim 19, wherein the ladder stand includes a support rail that is rotatable between a stowed state in which entry into or departure out of the ladder stand is allowed, and a deployed state in which entry into or departure out of the ladder stand is restricted, and wherein the hem attaches to the support rail when the support rail is in the deployed state to facilitate grip between the hunting blind and the support rail.
